(19) United States
(12) Patent Application Publication
(10) Pub. No.: US 2003/0080194 A1
(43) Pub. Date: May 1, 2003

(54) Biometric water mixing valve

(76) Inventors: Sean M. O'Hara, Lebanon, OR (US); Evan Scheessele, Corvallis, OR (US); Michael D. Johnson, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/046,335

(22) Filed: Oct. 25, 2001

(51) Int. Cl. G05D 23/13; G05D 23/00

(52) U.S. Cl. 236/12.12; 236/51

(57) ABSTRACT

A biometric water mixing valve uses a measured biometric characteristic to identify a user and to identify the user's preferred output water temperature and/or output water volume. Hot and cold water flow are mixed in amounts required to yield an output discharge temperature that the identified user prefers. By using a biometric characteristic, a preferred discharge water temperature and/or volume can be achieved merely by having the biometric characteristic scanned.

### BACKGROUND OF THE INVENTION

Domestic water mixing valves establish a water discharge temperature by mixing hot and cold water. The nearly ubiquitous single-handle faucets sold by a variety of manufacturers mix hot water and cold water in varying amounts by the rotation of a handle coupled to a valve that controls both water supplies. Dual-handle mixing valves that have two separate valves, the outputs of which are directed to a single discharge, separately control the amount of water that passes through each but effectively establish a discharge water temperature by mixing hot and cold water together.

A shortcoming of prior art domestic water mixing valves is their inability to conveniently re-establish a water discharge temperature that a user prefers after he or she closes the valve. Some amount of “fiddling” with the valve or valves is almost always required to set the water discharge temperature to the temperature at which a person prefers. As a matter of convenience, a water mixing valve that could conveniently re-establish a discharge temperature that each person in a household prefers and on a person-by-person basis would provide an added level of comfort and convenience.

### SUMMARY OF THE INVENTION

A processor-controlled water mixing valve is provided that measures output water stream temperature and controllably mixes the hot and cold water supplies to achieve a predetermined target discharge water temperature that is specified by a person who is identified to the water mixing valve by one or more biometric characteristics.

### BRIEF DESCRIPTION OF THE DRAWINGS

FIG. 1 shows a block diagram of a preferred embodiment of a biometric water mixing valve.

FIG. 2 shows steps of a method for automatically establishing an output water temperature using a biometric characteristic.

FIG. 3 shows additional steps of the method depicted in FIG. 2.

FIG. 4 shows the steps of a method for a biometric water mixing valve to learn a temperature preferred by an individual having a particular biometric characteristic.

FIG. 5 shows a flow chart of steps of a method to adjust water flows in a biometric water mixing valve to achieve a particular temperature.

FIG. 6 shows an alternate embodiment of a biometric water mixing valve using a Bluetooth communications system to send and receive data.

### DETAILED DESCRIPTION OF THE PREFERRED EMBODIMENT

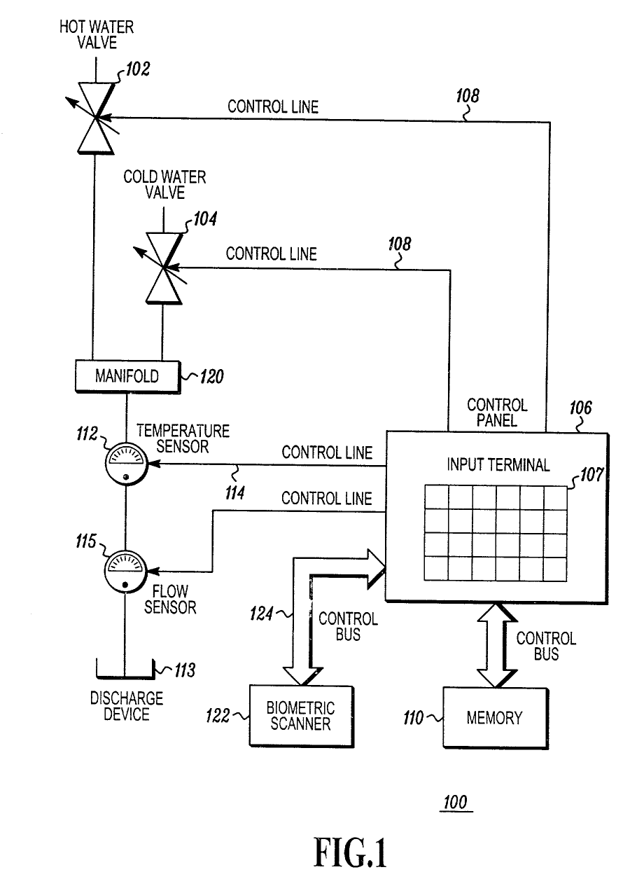

FIG. 1 shows a simplified block diagram of a preferred embodiment of a computer-controlled mixing valve 100 that adjusts input water flows to maintain an output water temperature according to a biometric characteristic identifying a person operating the valve 100. Specialty control valves 102 and 104 are manually operable such that the water discharge temperature can be set by a user by manually rotating the valve stems, however, the valves are also electrically readable and electrically operable by being electrically coupled to a processor 106 via address and control lines 108.

Electrical signals exchanged between the valves 102 and 104 and the processor 106 signal the position of the valves to the processor 106 but also enable the processor 106 to adjust the valve positions by way of electrical control motors on each valve 102 and 104. Specialty valves 102 and 104 are equipped with shaft encoders (not shown) by which their rotational positions can be sensed or read by the processor 106 under software control via the bus 108. The valves 102 and 104 are considered specialty valves because there are also equipped with stepper motors (or equivalents, not shown) that are operatively coupled to the processor 106 via the bus 108 so as to enable the processor 106 to control the opening and closing of the valves under software control by the processor 106.

Water passing through the valves 102 and 104 is mixed in a manifold 120 having a water discharge or outlet. The manifold 120 in which water from both valves is mixed, can be any volume in which hot and cold water can be combined and discharged into a pipe for delivery to a user.

In FIG. 1, a temperature sensor 112 such as thermistor, is thermally coupled to the water that is mixed in the manifold 120. The temperature sensor 112 is electrically coupled to the processor 106 by another control bus 114 such that the processor 106 can read or sense the water temperature via the sensor 112. Water from the manifold 120 is routed to a shower head or other discharge device 113.

As water passes through the control valves 102 and 104, the volume that each valve 102, 104 passes is directly related to the rotational position of the control valves 102 and 104. By manually rotating the valve stems so as to open or close them, the valve stem positions are sensed by the aforementioned shaft encoders in order to generate a signal that can be understood by the processor 106. As the valves 102, 104 position change, differences in hot and cold water delivery rates will vary the measured discharge water temperature.

Closed-loop control of the output water temperature is achieved by sensing the output water temperature by the sensor 112 and adjusting the water valves 102 and 104 so as to maintain a substantially constant output water temperature. In order to achieve closed-loop water temperature control, the processor 106 reads the discharge temperature from the sensor 112 and adjusts valve 102, 104 positions under software control. Those skilled in the art will recognize of course that upon the depletion of a hot water supply, no amount of adjustment of the input valves 102 and 104 will effect a constant output temperature greater than the temperature of the cold water supply.

In addition to providing closed-loop water temperature control, the valve depicted in FIG. 1 maintains the output water temperature according to a parameter associated with a person, whose identity is established by biometric characteristics read through a biometric sensor 122. A thumbprint or fingerprint scanner, retina scanner or iris scanner are examples of biometric sensors that can uniquely identify an individual. A biometric characteristic, such as a thumbprint, is read by the processor and stored in memory and associated with a preferred output temperature such that when a finger print is recognized, the processor 106 identifies the person by finger print and then re-sets output water temperature for the person.

In a first alternate embodiment, a biometric-characteristic control valve includes a biometric sensor 122 to identify a particular user, but does not include an output water temperature sensor 112. In such an alternate embodiment, once a user is identified by his or her biometric characteristics, the processor 106 software will set the positions of the valves 102 and 104 to positions previously determined to achieve a desired output temperature. In such an alternate embodiment, the desired discharge water temperature (desired by an individual that was recognized by the processor using the aforementioned biometric characteristic) is first set by a user manually positioning the valves 102 and 104. When a desired output water temperature is achieved, a user signals the processor 106 to read the valve stem positions by having the processor 106 read shaft encoders that indicate stem positions and thereafter saving the shaft encoder data to memory.

At a later date or time after the valves are closed or manually adjusted, the processor can return the valve stems to the positions at which the desired water temperature was achieved by having the processor re-read the valve 102 and 104 positions and comparing the valve stem positions to the positions at which the desired temperature was achieved. The processor can readily adjust the valve positions to return the valves 102 and 104 to the positions at which the desired temperature was achieved.

In a second alternate embodiment, only one control valve 102 on the hot water supply line is used to modulate the discharge temperature from the manifold 120. Inasmuch as the mixing valve 100 is usually used to control an elevated temperature, adjusting a hot water supply can in some instances provide effective control of a discharge temperature. Providing two control valves 102 and 104 will almost always provide superior performance over that which is possible using a single valve.

In a third alternate embodiment, the water valves 102 and 104 are not manually operable nor do they include shaft encoders or other mechanisms by which the valve stem positions can be read by the processor 106. Instead, the valves 102 an 104 and are only controllable (operable) by the processor 106 via the control bus 108.

In the third alternate embodiment, a user issues input signals to the processor 106 via a control panel 107 to instruct the processor to issue signals to the control valves 102 and 104 via the bus 108 to open or close. In response to the processor's signals, the valves 102 and 104 increase or decrease their openings so as to increase or decrease the hot and cold water flowing through each valve thereby adjusting the temperature of the resultant mixture of hot and cold water in the manifold 120.

A desired discharge water temperature can be achieved by instructing the processor 106 to adjust the position of the control valves 102 and 104 from control panel 107 inputs. Once a desired temperature is achieved, a second input command to the processor 106 via control panel 107 instructs the processor to record in memory, the data signals that were required to position the valves. The processor can then solicit and scan a biometric characteristic, which is also stored in memory and to index the valve positions against the measured biometric characteristic.

In yet another embodiment, a desired output temperature is specified to the processor 106 from the input panel 107. In such an embodiment, the processor 106 tracks discharge temperature and adjusts the input valve or valves to supply the user-specified water temperature. This user-specified water temperature can be re-specified at a later date by using a finger print or other biometric characteristic to identify the person who first specified it and later requests it.

In yet another embodiment, a user can specify a certain volume of water or a certain time that the water should be run. By knowing a priori a volumetric flow rate through each valve 102 and 104 or each supply, a volume of water to be delivered can be readily calculated. A real-time timer in the processor can be used to keep track of how long the valves are kept open.

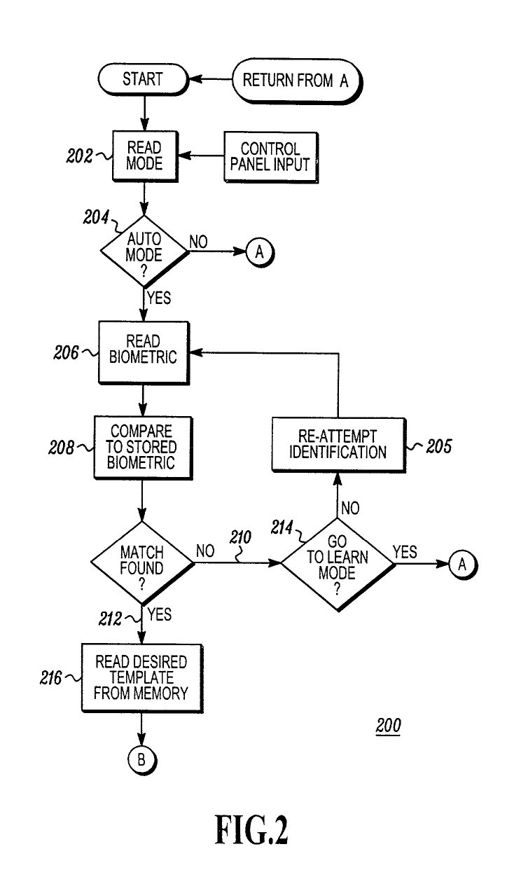

FIG. 2 depicts the steps of a method by which a biometric characteristic can be used to signal to a processor, a desired output water discharge temperature thereby maintaining a relatively constant discharge water temperature. Except as indicated, FIG. 2 pertains to the preferred embodiment of a biometric water mixing valve depicted in FIG. 1, which has two, specialty water flow control valves 102 and 104, an output temperature sensor 112 and a biometric characteristic sensor embodied as a finger print reader. By using a biometric characteristics, different individuals can program the valve to set different discharge temperatures.

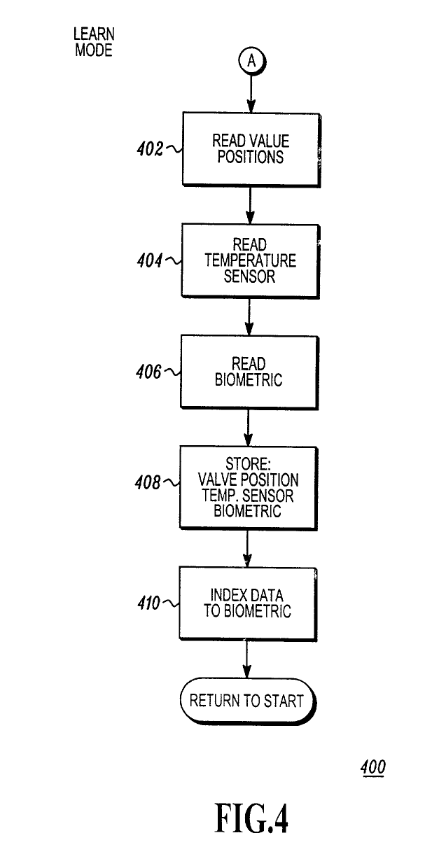

In step 202, the processor 106 reads the control panel 107 input to detect user input commands. Examples of user input commands include a “learn” mode in which a biometric characteristic of a user is obtained and that user's desired output temperature determined. Entry to the “learn” mode is shown in FIG. 2 by routine “A” the steps of which are shown in FIG. 4. In addition to entry into a “learn” mode, input commands to the processor detected in step 202 would include commands to: shut the water off; adjust delivery pressure; measure or calculate the volume of water delivered and shut off the water after a specified volume was delivered; reach a predetermined user set water temperature; and turn the water on again.

In step 204, a determination is made as to whether the user wishes to enter the “learn” mode. If the user does not select the “learn” mode, the program assumes that the identity of the user is already known and therefore proceeds to set an output water temperature.

In step 206, a biometric characteristic is read from the biometric scanner 122. In step 208, the biometric characteristic that was read in step 206 is compared to the representations of biometric characteristics that are stored in memory 110. In step 210, if no match is made to an already stored characteristic, the program attempts to ascertain whether the user is a new user and therefore queries the user if the “learn” mode should be entered in step 214. If the user does not affirmatively select the “learn” mode, program control returns to step 206 to re-try the biometric character reading. In bathroom environments where humidity, scale and contaminants abound, re-attempting the biometric scan by steps 210 and 206 enables the biometric mixing valve to more reliably identify a user.

In step 212, if a biometric characteristic that is read at the scanner 122 matches a stored characteristic in memory 110, the program presumes that the user whose finger print, retina, iris or other characteristic was read in step 206 is the person whose identifying data was located in memory 110. Using the stored biometric data as an index or pointer to one or more locations in memory 110, where a desired temperature is stored, the processor 106 reads the identified-user's preferred water settings from memory 110 in step 216.

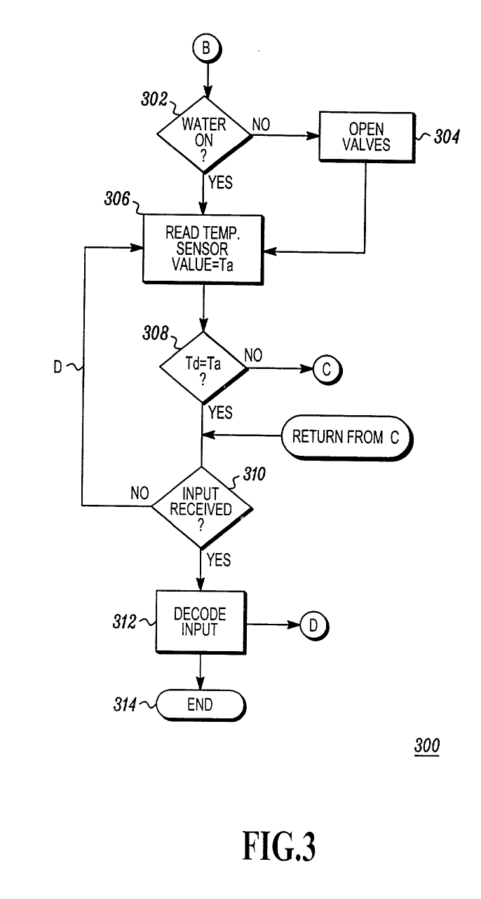

FIG. 3 shows the continuation of the program steps depicted in FIG. 2.

In FIG. 3, step 302 shows that a determination is made as to whether the water is on. In step 304, the valves 102 and 104 are opened. In the aforementioned alternate embodiment comprised of only a single valve, step 302 would of course require an operable valve mechanism for both hot and cold water supplies.

After the water valves 102 and 104 are opened, in step 306, the preferred embodiment, the temperature sensor 112 is read to determine the temperature of the water being discharged from the manifold 120. In the aforementioned embodiment that does not use an output water temperature sensor and which only opens the valves to a predetermined amount, real-time closed-loop adjustment of discharge temperature under software control is not possible. Steps 306, 308 and 310 are not executed in embodiments of the biometric mixing valve that do not sense output water temperature.

In step 308, the temperature desired by the user that was identified by a biometric characteristic is compared to the temperature as sensed by the temperature sensor 112 in step 306. If the temperature sensed and the user's desired temperature happen to be substantially the same, program control returns to step 306 and loops continuously until an input command from the input terminal 107 is detected in step 310.

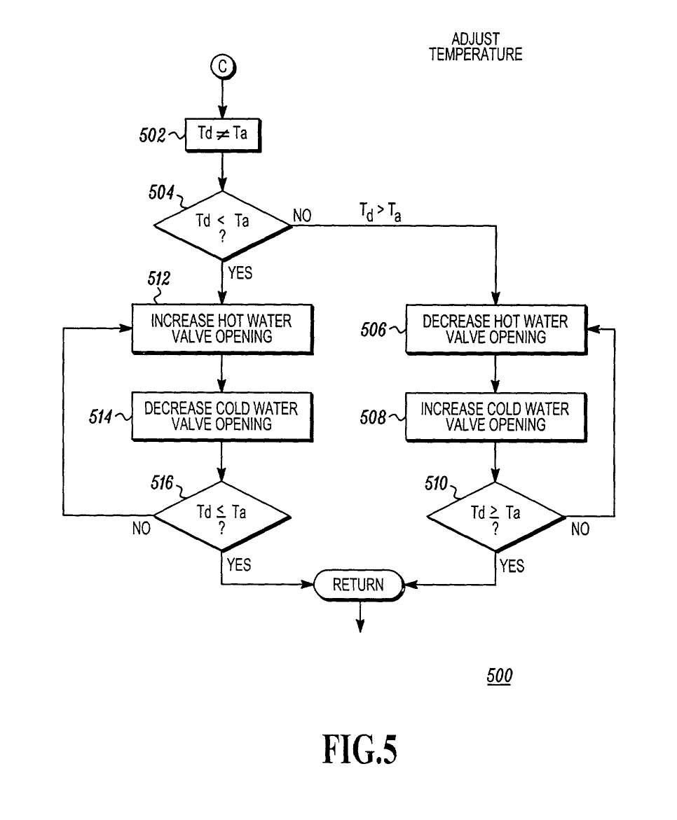

In the event that the temperature of the water as measured by the temperature sensor 112 is not substantially equal to the user's desired temperature, program control jumps to routine “C” which adjusts the input water flows under program control as shown in FIG. 5 in order to attempt to set the discharge water temperature to the user's specification.

If an input at the terminal 107 is detected in step 312, that input command is processed and executed. The details of processing and executing an input command are not germane to the invention disclosed and claimed herein and for that reason are omitted for clarity. Examples of program inputs that should interrupt the program loop “D” would include a terminal input command to shut off the water and increase or decrease the discharge temperature.

Program execution is shown terminating at step 314.

FIG. 4 depicts the steps of a “learn” mode to be practiced in biometric water mixing valves 100 equipped with valves 102 and 104 that are manually-operable and which include valve stem position sensors by which the valve positional state can be electronically read and which include drive motors by which the valve postitional state can be adjusted under software control.

In step 402, the processor reads the position of valve stems (when using valves equipped with rotating valve stems), preferably by using shaft encoders, which have digital outputs corresponding to the rotational position of a shaft (i.e. a valve stem) to which the encoder is coupled. In alternate embodiments that do not read the valve positions, step 402 is not performed.

For the embodiment of a biometric water mixing valve 100 that is depicted in FIG. 1, the valves 102 and 104 include special features in that they are manually operable but in addition, the amount by which the valves 102 and 104 are opened or closed can be read by the processor 106 under software control. The valves 102 and 104 can also be adjusted by the processor 106 under software control. The valves 102 and 104 might be embodied as gate or ball valves equipped with shaft encoders to read shaft position but also include electrically operated drive motors coupled to the valve stems in order to control the valve positions.

In the learn mode 400 shown in FIG. 4, the user sets the valves 102, 104 to obtain his or her desired discharge water temperature. After doing so, in step 404, the temperature of the water discharged from the manifold is read from the sensor 112 by the processor 106. After having ascertained what the user-set discharge water temperature is, the processor reads a biometric characteristic of the individual in step 406 so as to identify who set the temperature that was read in step 404. A control loop (not shown) can be readily added to step 406 in order to inhibit subsequent steps until a biometric characteristic is read.

After the biometric characteristic is read in step 406, it is stored in memory 110 along with the valve position data in step 408. In step 410, the data stored in step 408 is indexed (or assigned to) an address in memory 110 by which it can be subsequently recovered from memory 110 and used to re-set the valves 102 and 104 in order to re-establish the user's desired output temperature as constant as possible.

Adjusting and maintaining the biometric water mixing valve discharge water temperature requires adjusting the volume of hot and cold water that are combined within the valve. In the preferred embodiment, discharge water temperature is sensed and in response thereto, the hot and cold water valves are adjusted to attempt to maintain a constant output temperature. FIG. 5 shows the steps of a method by which the discharge temperature from the manifold 120 is adjusted under software control.

In step 502, a comparison of the user's preferred temperature and the actual discharge temperature, as measured by the sensor 112 are compared.

In step 504, if the discharge temperature is greater than the desired temperature, the biometric water mixing valve processor must correct the hot/cold water mixture. To reduce the discharge temperature, either more cold water is needed, or less hot water is needed, or both conditions, more cold and less hot are needed.

In step 506, the hot water valve opening is decreased by some predetermined amount accompanied by an increase in the cold water in step 508. After the hot and cold water valves are adjusted, the temperature sensor is read again and compared against the user's preferred temperature. If the desired temperature has not been reached, program control returns to step 506 as shown.

If in step 504 it is determined that the discharge water temperature is too cold, step 512 and 514 are executed which incrementally open the hot water valve and cold water valve respectively followed by a re-test of the discharge water temperature in step 516. If the discharge water temperature needs an additional increase, program control reverts to step 512. It can be seen in FIG. 5 that the discharge water temperature is maintained by continuously checking discharge water temperature and incrementally opening and closing the water valves 102 and 104 under program control.

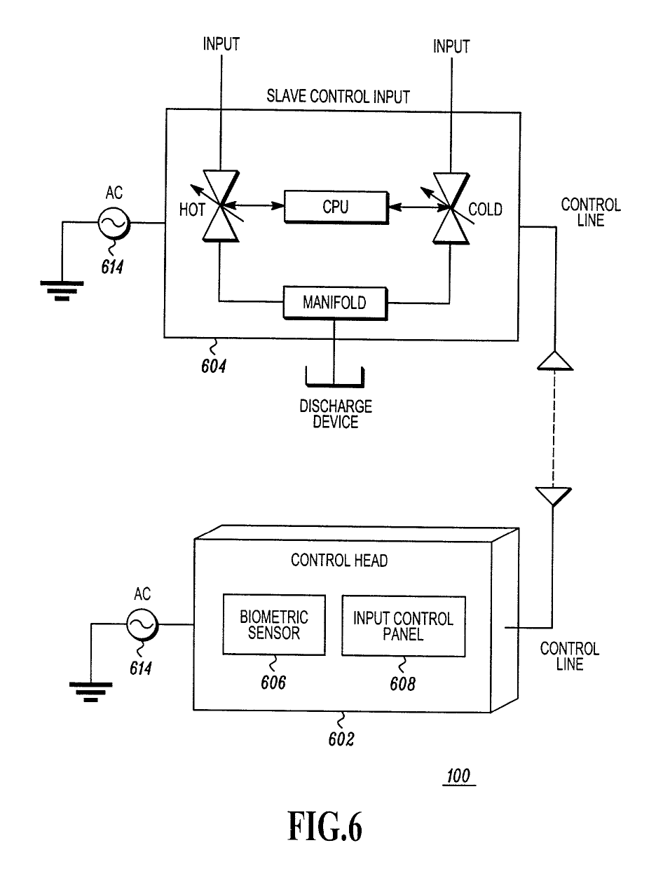

FIG. 6 depicts yet another embodiment of a biometric water mixing valve 600 comprised of a control head 602 and a slave control valve 604 which communicate with each other via data control lines or a wireless communications protocol such as Bluetooth, the detailed specification of which are available at www.bluetooth.com.

In FIG. 6, the control head 602 includes a biometric sensor 606 that is coupled to a processor (not shown) such as that depicted in FIG. 1. An input control panel 608 accepts user input commands such as a desired output temperature, start time, off time and a volumetric limit at which the water should be shut off. The slave control valve 604 contains the mechanical valves and sensors by which water flow is controlled. The slave unit 604 and the control head 602 exchange signals with each other using data control lines or wireless communication protocols such as Bluetooth by which the slave unit and the control head can be remotely located from each other, subject of course to the limitation that both units require electrical power 614 to operate.

By using a biometric characteristic sensor, such as a fingerprint sensor, retinal scanner or iris scanner, a biometric characteristic can be used to uniquely control water discharge temperature for individuals who are uniquely identified by a biometric characteristic. In plumbing system applications such as domestic water systems, a biometric water mixing valve provides an additional level of convenience heretofore not provided by the prior art mixing valves.

What is claimed is:

1. An intelligent water mixing valve comprised of:
a water manifold having a cold water inlet and a hot water inlet;
a hot water supply control valve, electrically operable in response to signals from a computer having an input and an output;
a hot water supply operably coupled to the input of said hot water control valve;
a processor, operably coupled to said hot water control valve;
a temperature sensor, on the output of said water mixing manifold, said temperature sensor operably coupled to said microprocessor;
a flow sensor, on the output of said water mixing manifold, said flow sensor operably coupled to said microprocessor;
a biometric characteristic sensor, capable of recognizing at least one biometric characteristic of an individual, said biometric sensor being operably coupled to an input of said microprocessor for collecting biometric characteristics and sending electrical signals representative thereof to said processor.

2. The intelligent mixing control valve of claim 1 wherein said biometric characteristic is a fingerprint sensor.

3. The intelligent control valve of claim 1 wherein said biometric sensor is a retinal scanner.

4. The intelligent mixing valve of claim 1 wherein said biometric sensor is an iris scanner.

5. The intelligent control valve of claim 1 further including a second, electrically operable flow control valve operably coupled between said mixing manifold and said cold water supply and coupled to said microprocessor.

6. An intelligent water mixing valve comprised of:
a water manifold having a cold water inlet and a hot water inlet and an output;
a cold water supply;
a manually-operable cold water supply valve coupled to said cold water supply, electrically operable in response to signals from a computer and further having a cold water output, said cold water output coupled to the water manifold cold water input;
a hot water supply;
a manually-operable hot water supply control valve, coupled to said hot water supply, electrically operable in response to signals from a computer further having a hot water output, said hot water output coupled to said water manifold hot water input;
a temperature sensor, thermally coupled to the output of said water manifold;
a flow sensor, on the output of said water mixing manifold, said flow sensor operably coupled to said microprocessor;
a biometric characteristic sensor, capable of recognizing at least one biometric characteristic of an individual, said biometric sensor for collecting biometric characteristics and sending electrical signals representative thereof to a processor;
a processor, operably coupled to said hot water control valve and to said cold water supply valve; to said temperature sensor and to said biometric characteristic sensor;
whereby said processor reads said temperature sensor and adjusts at least one of said hot and cold water supply valves to establish a discharge water temperature from said manifold.

7. The water mixing valve of claim 6 wherein each of said hot and cold water valves include means for sensing the amount by which said valve is open.

8. The water mixing valve of claim 6 wherein each of said hot and cold water valves include a shaft encoder to detect the amount by which the valve stems of said valves are open.

9. The water mixing valve of claim 6 further including a user input terminal into which user input commands to said valve are received.

10. An intelligent water mixing valve comprised of:
a water manifold having a cold water inlet and a hot water inlet and an output;
a cold water supply;
a manually-operable cold water supply valve coupled to said cold water supply, electrically operable in response to signals from a computer and further having a cold water output, said cold water output coupled to the water manifold cold water input;
a hot water supply;
a manually-operable hot water supply control valve, coupled to said hot water supply, electrically operable in response to signals from a computer further having a hot water output, said hot water output coupled to said water manifold hot water input;
a temperature sensor, thermally coupled to the output of said water manifold;
a flow sensor, on the output of said water mixing manifold, said flow sensor operably coupled to said microprocessor;
a biometric characteristic sensor, capable of recognizing at least one biometric characteristic of an individual, said biometric sensor for collecting biometric characteristics and sending electrical signals representative thereof to a processor;
a processor, operably coupled to said hot water control valve and to said cold water supply valve; to said temperature sensor and to said biometric characteristic sensor and a timer;
whereby said processor reads said temperature sensor and adjusts at least one of said hot and cold water supply valves to establish a discharge water temperature from said manifold and to calculate a volume of water to be delivered, or a time over which water should be provided.

11. The water mixing valve of claim 10 wherein each of said hot and cold water valves include means for sensing the amount by which said valve is open.

12. The water mixing valve of claim 10 wherein each of said hot and cold water valves include a shaft encoder to detect the amount by which the valve stems of said valves are open.

13. The water mixing valve of claim 10 further including a user input terminal into which user input commands to said valve are received.

14. A method of automatically maintaining a discharge water temperature from a mixing valve comprised of the steps of:
sensing a discharge water temperature;
reading a biometric characteristic;
identifying at least one individual and said individual's desired discharge temperature using said biometric characteristic;
adjusting at least one of a hot water source and a cold water source by incremental amounts until said discharge temperature and said desired discharge temperature are substantially the same.

15. A method of automatically maintaining a discharge water temperature from a mixing valve comprised of the steps of:
reading a biometric characteristic;
identifying at least one individual and said individual's desired discharge temperature using said biometric characteristic;
sensing a discharge water temperature;
adjusting at least one of a hot water source and a cold water source by incremental amounts until said discharge temperature and said desired discharge temperature are substantially the same.

16. A method of automatically maintaining a discharge water temperature from a mixing valve comprised of the steps of:
reading a biometric characteristic;
identifying at least one individual and said individual's desired discharge temperature using said biometric characteristic;
sensing a discharge water temperature and wirelessly transmitting said discharge water temperature to a processor;
determining whether hot water or cold water delivery should be increased to achieve said individuals desired discharge temperature;
wirelessly transmitting control signals to controllable water valves to adjust at least one of a hot water source and a cold water source by incremental amounts until said discharge temperature and said desired discharge temperature are substantially the same.

17. A method of automatically maintaining a discharge water volume from a mixing valve comprised of the steps of:
reading a biometric characteristic;
identifying at least one individual and said individual's desired discharge volume using said biometric characteristic;
sensing a discharge water volume and wirelessly transmitting said discharge water volume to a processor;
determining whether water delivery should be continued to achieve said individuals desired discharge volume;
wirelessly transmitting control signals to controllable water valves to adjust water source by incremental amounts until said discharge volume and said desired discharge volume are substantially the same.
